(19) United States
(12) Patent Application Publication
(10) Pub. No.: US 2009/0263562 A1
(43) Pub. Date: Oct. 22, 2009

(54) PROCESS FOR MAKING NUT SPREADS

(76) Inventors: ROBERT ANTHONY CANASTRO, Kapaa, HI (US); Brigid Canastro, Kapaa, HI (US)

Correspondence Address: CHRISTIE, PARKER & HALE, LLP, PO BOX 7068, PASADENA, CA, 91109-7068, US

(21) Appl. No.: 12/428,223

(22) Filed: Apr. 22, 2009

Related U.S. Application Data
(60) Provisional application No. 61/125,185, filed on Apr. 22, 2008.

(51) Int. Cl. A23L 1/36

(52) U.S. Cl. 426/617; 426/633

(57) ABSTRACT

A nut spread made from a blend of ground macadamia nuts and/or almonds and honey, in which the honey is the major component and provides a binder for the paste-like edible spread, as well as controlling flavor, texture and spreadability of the resulting food product.

### CROSS-REFERENCE TO RELATED APPLICATION

This application claims the benefit of and priority to U.S. Provisional Application 61/125,185, filed Apr. 22, 2008, which is fully incorporated herein by this reference.

### FIELD OF THE INVENTION

This invention relates to a process for making a nut spreads from a combination of macadamia nuts and/or almonds and honey.

### BACKGROUND

Nut-based spreads are popular because they provide a source of protein and they generally have a desired level of fluidity, texture and flavor.

We have observed that macadamia nuts are especially high in food quality or nutritional value, but are not commonly used as a nut spread similar to peanut butter, for example.

Macadamia nuts are generally known to be native to regions of Australia, but they are also plentiful in the Hawaiian Islands. The nut kernel contains about 65-85% oil and about 4-7% natural sugar, depending upon the variety. When roasted, macadamia nuts develop a uniform texture and color. Roasting (removing moisture) can remove some of the bitterness associated with the flavor of macadamia nuts.

One embodiment of the present invention provides a process for making a nut spread from a mixture of macadamia nuts and honey. The resulting product has a desirable level of texture and spreadability with excellent flavor, not to mention the nutritional quality.

We have also observed that almonds have many health benefits, such as LDL-lowering monounsaturated fats. They have been used in nutritional food products such as almond butter, but these products lack the texture, flavor and spreadability to make them more popular, generally.

### SUMMARY OF THE INVENTION

Briefly, one embodiment of the invention comprises a process for making a nut spread which includes the steps of providing, as starting materials, honey and nuts comprising macadamia nuts and/or almonds which have been roasted to remove moisture, and blending the roasted nuts and the honey to form a paste-like edible ground nut spread in which the honey is present as a binder in a greater weight-percent than the ground nuts.

Another embodiment of the invention comprises a nut spread comprising a blended mixture of honey and macadamia nuts which have been roasted to remove moisture prior to blending with the honey, in which the resulting blended material forms a paste-like edible nut spread in which the honey is present in a greater weight percent than the macadamia nuts.

The honey provides a useful binder for the ground macadamia nuts, enhancing fluidity and/or spreadability of the nut spread, while also adding a flavor component that avoids bitterness in the blended material from the macadamia nuts.

A further embodiment of the invention provides a similar process for making a nut spread from almonds and honey.

### DETAILED DESCRIPTION

According to one embodiment of this invention, the starting materials used in the process of this invention are macadamia nuts and honey.

The honey used in the process described below is natural honey, no preservatives or other additives. The honey is extracted in the usual way, and at a natural moisture content, available in the cells of the honeycomb. The processing includes cutting off the capping, and loading the frames into an extractor or centrifuge used to remove the honey from the cells. The extracted honey is retained in a settling tank and then strained by pouring it through a mesh screen to remove small pieces of wax. The honey is not heated as part of the extraction or filtering process. The honey used in the process also is not filtered, in the sense of passing it through conventional fine filters, which normally requires heating and can detrimentally affect the quality of the otherwise natural honey.

The macadamia nuts are those which are of the edible variety, and preferably from a source available on the Big Island of Hawaii, although, other sources of macadamia nuts can be used. The macadamia nuts can be the smooth shelled or the slightly pebbled varieties. The macadamia nuts used as the starting material are diced, unsalted, and lightly roasted to remove moisture. In one embodiment, the diced nuts are roasted for about 15 to 20 minutes at about 165° degrees F. Alternatively, the nuts can be heated at about 100° to 115° degrees F., for about 12 hours. The roasting step enhances the flavor of the nut component and removes moisture to keep out of the honey blend so as to not adversely affect flavor. The nuts are not allowed to cook during the roasting or drying step. Excessive heat damages the flavor quality of the nut component. Any storage of the nuts after roasting or drying is under conditions that avoid moisture absorption.

The honey and nuts are then blended in a commercial grade blender, such as a Champion blender. The honey is added to the mixture at ambient, room temperature. The proportions used in the mixture are generally more honey than the macadamia nut component, by weight. In one embodiment, the mixture is generally from about 30% to about 40% macadamia nuts, and from about 60% to about 70% honey, by weight. A preferred macadamia nut-honey content is from about 33% to about 37% macadamia nuts, and from about 63% to about 67% honey, by weight. In one example, good results are developed in a mixture containing about 4 ounces macadamia nuts and from about 7 to about 8 ounces honey, to produce an 11 to 12 ounce spread.

The mixture is preferably blended at high speed in the commercial blender to effectively grind the nuts into a paste-like consistency. If too much honey is used, the spread is too runny. But the honey must be used in a sufficient amount to properly adjust viscosity and avoid the spread being too thick, too light in weight, and not having enough honey (for flavor and for its binder qualities). Avoiding too much honey also avoids the spread from separating in the jar.

The macadamia nuts can generally have a bitterness along with their nutritional quality, but the honey component overcomes any hint of bitterness normally associated with macadamia nuts in the finished nut spread product. The honey also is effective as a binder for the ground up nuts for providing excellent spreadability, texture and flavor in the finished nut spread.

In another embodiment, a small amount of coconut is added to the same macadamia nut/honey mixture as described above. Generally, the coconut is added in an amount from about 2% to about 4% by weight of the total solids in the blended material. In one example, about one tablespoon (or about ½ ounce) of coconut is added to a macadamia nut base and the two solid ingredients are blended prior to mixing in the honey. The coconut is preferably unsalted, unsulfured, and shredded prior to blending it with the macadamia nuts. The coconut adds a different flavor note and also assists in avoiding any bitterness to the overall flavor from the macadamia nuts.

In a further embodiment of the invention, the starting materials for the process are almonds and honey. The honey used in the process is similar to that described previously.

The almonds are lightly roasted, as described previously, to remove moisture and enhance flavor without cooking or otherwise adversely effecting the flavor.

The honey and roasted almond nuts are then blended, as described previously, to produce a mixture containing from about 30% to about 40% nuts (ground almonds) and from about 60% to about 70% honey, by weight. One example comprises a mixture containing about 4 ounces ground almond nuts and about 7 to 8 ounces honey, to produce an 11 to 12 ounce nut spread.

In another embodiment, the nut spread of this invention can comprise macadamia nuts and almonds blended in different proportions to produce a ground nut component present in the finished product in a range from about 30% to about 40%, with the balance being from about 60% to about 70% honey, by weight.

What is claimed is:

1. A process for making an edible nut spread comprising the steps of providing, as starting materials, honey and nuts comprising macadamia nuts and/or almonds which have been roasted to remove moisture from the nuts, and
blending the roasted nuts and the honey to form a paste-like edible ground nut spread in which the honey is present as a binder in a greater weight-percent than the ground nuts.

2. The process according to claim 1 in which the starting materials are blended to produce a nut spread comprising from about 60 percent to about 70 percent honey and from about 30 percent to about 40 percent macadamia nuts, by weight.

3. The process according to claim 2 in which the nut spread consists essentially of ground macadamia nuts and honey.

4. The process according to claim 2 including adding coconut to the blended nut spread.

5. The process according to claim 4 in which the coconut is present in an amount from about 2 percent to about 4 percent, by weight, of the total solids in the nut spread.

6. The process according to claim 1 in which the nut spread consists essentially of macadamia nuts, honey and coconut.

7. The process according to claim 1 in which the starting materials are blended to produce a nut spread comprising from about 33 percent to about 37 percent by weight macadamia nuts and from about 63 to about 67 percent by weight honey.

8. The process according to claim 1 in which the honey is essentially unheated prior to combining it with the macadamia nuts.

9. The process according to claim 1 in which the nuts contained in the ground nut spread consist essentially of macadamia nuts, almonds, or mixtures thereof.

10. A nut spread comprising a blended mixture of honey and macadamia nuts which have been roasted to remove moisture prior to blending with the honey, in which the resulting blended material forms a paste-like edible nut spread in which the honey is present as a binder in a greater weight-percent than the macadamia nuts.

11. The product according to claim 10 in which the starting materials are blended to produce a nut spread comprising from about 60 percent to about 70 percent honey and from about 30 percent to about 40 percent macadamia nuts by weight.

12. The product according to claim 11 in which the nut spread consists essentially of macadamia nuts and honey.

13. The product according to claim 11 including coconut added to the blended nut spread.

14. The product according to claim 13 in which the coconut is present in an amount from about 2 percent to about 4 percent of the total solids in the nut spread.

15. The product according to claim 1 in which the nut spread consists essentially of macadamia nuts, honey and coconut.

16. The product according to claim 10 in which the starting materials are blended to 10 produce a nut spread comprising from about 33 percent to about 37 percent by weight macadamia nuts and from about 63 to about 67 percent by weight honey.

17. A nut spread comprising a blended mixture of honey and almond nuts which have been roasted to remove moisture prior to blending with the honey, in which the resulting blended is material forms a paste-like edible nut spread in which the honey is present as a binder in a greater weight-percent than the almond nuts.

18. The product according to claim 17 in which the starting materials are blended to produce a nut spread comprising from about 60 percent to about 70 percent honey and from about 30 percent to about 40 percent almond nuts by weight.

19. The product according to claim 18 in which the nut spread consists essentially of almond nuts and honey.

20. The product according to claim 17 in which the starting materials are blended to produce a nut spread comprising from about 33 percent to about 37 percent by weight almond nuts and from about 63 to about 67 percent by weight honey.
